(19) United States
(12) Patent Application Publication
(10) Pub. No.: US 2025/0252368 A1
(43) Pub. Date: Aug. 7, 2025

(54) VISUALIZATION METHOD, VISUALIZATION DEVICE, AND RECORDING MEDIUM

(71) Applicant: NEC Corporation, Minato-ku, Tokyo (JP)

(72) Inventors: Hanae SHIMOMURA, Tokyo (JP); Riki Eto, Tokyo (JP); Dai Kubota, Tokyo (JP)

(73) Assignee: NEC Corporation, Minato-ku, Tokyo (JP)

(21) Appl. No.: 18/702,380

(22) PCT Filed: Mar. 11, 2022
(86) PCT No.: PCT/JP2022/010901

§ 371 Date: Apr. 18, 2024

(51) Int. Cl. G06Q 10/0631; G06N 3/092; G06Q 10/04

(52) U.S. Cl. CPC G06Q 10/063112; G06N 3/092; G06Q 10/04

(57) ABSTRACT

This visualization device comprises an acquisition unit and an output control unit. The acquisition unit acquires, for each of a plurality of different solutions to an optimization problem which are obtained on the basis of an objective function, feature amount values of the objective function for each solution. The output control unit outputs, in a comparable manner, the feature amount values acquired for the optimal solution among the plurality of solutions and the feature amount values acquired for executable solutions among the plurality of solutions.

### TECHNICAL FIELD

The present disclosure relates to a visualization method and the like.

### BACKGROUND ART

In the optimization problem, a function to maximize or minimize a solution under given constraints is called an objective function.

For example, there is a technology in which, when the results of a plurality of solutions obtained based on an objective function are graphically displayed, the importance level or constraints of each evaluation item used for calculation of the solution are reflected on an axis or the background of the axis (see, for example, PTL 1).

For example, there is a technology of learning an objective function based on a decision-making history of a subject (see, for example, PTL 2).

### CITATION LIST

### Patent Literature

PTL 1: WO 2013/179577 A1
PTL 2: WO 2021/130916 A1

### SUMMARY OF INVENTION

### Technical Problem

In a case where an optimal solution is obtained by an objective function, there is a problem that it is difficult to understand whether it is appropriate to use the optimal solution.

An example of the object of the present disclosure is to provide a visualization method and the like for improving ease of checking each solution obtained by an objective function.

### Solution to Problem

A visualization method according to an aspect of the present disclosure includes acquiring, for each of a plurality of solutions different from one another of an optimization problem obtained based on an objective function, a value of a feature quantity of the objective function in each of the solutions and outputting a value of the feature quantity acquired for an optimal solution among the plurality of solutions and a value of the feature quantity acquired for a feasible solution among the plurality of solutions in a comparable manner.

A visualization device according to an aspect of the present disclosure includes an acquisition means for acquiring, for each of a plurality of solutions different from one another of an optimization problem obtained based on an objective function, a value of a feature quantity of the objective function in each of the solutions and an output control means for outputting a value of the feature quantity acquired for an optimal solution among the plurality of solutions and a value of the feature quantity acquired for a feasible solution among the plurality of solutions in a comparable manner.

A program according to an aspect of the present disclosure causes a computer to acquire, for each of a plurality of solutions different from one another of an optimization problem obtained based on an objective function, an index value of a feature quantity of the objective function in each of the solutions and output a value of the feature quantity acquired for an optimal solution among the plurality of solutions and a value of the feature quantity acquired for a feasible solution among the plurality of solutions in a comparable manner.

The program may be stored in a non-transitory computer-readable recording medium.

### Advantageous Effects of Invention

According to the present disclosure, it is possible to improve ease of checking each solution obtained by the objective function.

### BRIEF DESCRIPTION OF DRAWINGS

FIG. 1 is a block diagram illustrating a configuration example of a visualization device according to a first example embodiment.

FIG. 2 is a flowchart illustrating an operation example of the visualization device according to the first example embodiment.

FIG. 3 is a block diagram illustrating a configuration example of a visualization device according to a second example embodiment.

FIG. 4 is an explanatory diagram illustrating an example of a plurality of solutions.

FIG. 5 is an explanatory diagram illustrating a screen example of comparison display of index values.

FIG. 6 is an explanatory diagram illustrating a screen example for selecting a feature quantity of interest.

FIG. 7 is an explanatory diagram illustrating a screen example on which a graph is displayed.

FIG. 8 is a flowchart illustrating an operation example of the visualization device according to the second example embodiment.

FIG. 9 is an explanatory diagram illustrating a hardware configuration example of a computer.

### EXAMPLE EMBODIMENT

Hereinafter, example embodiments of a visualization method, a visualization device, a program, and a non-transitory recording medium for recording a program according to the present disclosure will be described in detail with reference to the drawings. The present example embodiment does not limit the disclosed technology.

First, the optimization problem is to obtain a solution that maximizes or minimizes a certain objective function under given constraints. In each example embodiment, the objective function has a viewpoint of evaluating the goodness of the optimization target as a feature quantity. The weighting of the feature quantity may be set based on experience or the like, or may be obtained by learning based on the decision-making history of the subject.

For example, when optimal shift creation is performed, “labor cost”, “degree of reflection of request for leave”, and the like can be cited as the feature quantity of the objective function. Weighting is performed on these feature quantities. In such a case, the creator of the shift intends to “set up a shift to keep labor costs as low as possible” and “set up a shift in such a way that the leave request can be heard as much as possible”.

Examples of the subject include a skilled person. There may be a plurality of subjects. Constraints are an item that needs to be followed at the time of decision-making. The feature quantity, that is, the viewpoint is an item considered at the time of decision-making.

The solutions obtained based on the objective function include an optimal solution and a feasible solution. The optimal solution is a solution that minimizes or maximizes the objective function. On the other hand, the feasible solution is not a minimized and maximized solution, but is a solution (allowable solution) satisfying predetermined constraints.

### First Example Embodiment

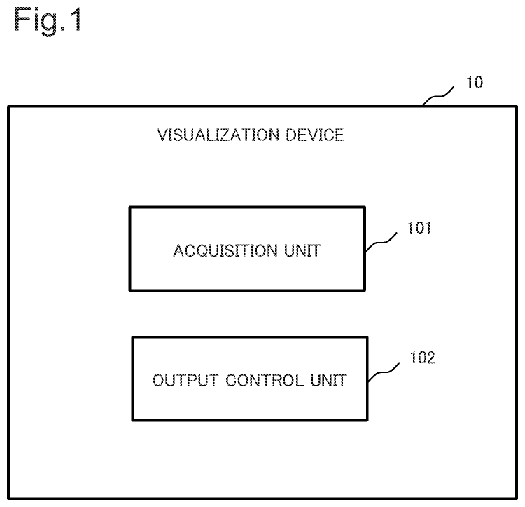

First, in a first example embodiment, the basic function of a visualization device will be described. FIG. 1 is a block diagram illustrating a configuration example of a visualization device according to the first example embodiment.

For example, the user optimizes the action by using the trained objective function. However, it is not always appropriate to use the minimized or maximized optimal solution in each use scene. Therefore, it is desirable that the user selects a solution suitable for each use scene with reference to a feasible solution other than the optimal solution. Therefore, a visualization device 10 visualizes the feature quantity affected by the solution for the optimal solution and the feasible solution obtained by the objective function. The feature quantity may be referred to as an index. In FIG. 1, the visualization device 10 includes an acquisition unit 101 and an output control unit 102.

The acquisition unit 101 acquires the value of the feature quantity of the objective function in each solution for each of a plurality of different solutions of the optimization problem obtained based on the row objective function. The objective function is an objective function reflecting an intention of a subject such as a skilled person. For example, the objective function is a reference for deriving an optimal solution of a certain action. For example, the weighting of the feature quantity of the objective function may be set based on experience or the like, or may be obtained by learning based on a decision-making history. This learning is, for example, inverse reinforcement learning. The objective function may be an objective function obtained by multi-objective optimization.

The action herein includes, for example, work. In the following description, there is a case where the description is made using work. For example, the action may be a work of determining some combination such as a work of determining the order of tasks or the like, a work of scheduling such as assigning a shift, a work of matching such as assigning a task, and allocation of resources for determining a combination of dishes within an upper limit of calories, and is not particularly limited. For example, the plurality of solutions includes the optimal solution and the feasible solution, as described above. The number of feasible solutions is not particularly limited.

Here, the value of the feature quantity may be referred to as an index value or an index value of the feature quantity. The index value will be described by taking an objective function of work for determining a work time schedule as an example. Examples of the feature quantity of the objective function include labor cost, the number of people, desire for leave, skill diversity, and compatibility between members. For example, when the feature quantity is the labor cost, the index value is the amount of labor cost in the solution. The amount of labor cost in the optimal solution may be different from the amount of labor cost in the feasible solution. The amount of labor cost in the optimal solution may be higher than the amount of labor cost in the feasible solution. As described above, when all of the plurality of feature quantities are considered, the optimal solution is obtained by minimizing or maximizing the objective function. However, when focusing on individual feature quantities, the optimal solution is not necessarily superior to other solutions.

The expression format of the index value is not particularly limited. The index value is a unit that differs according to the feature quantity. For example, when the feature quantity is a labor cost or the like, the unit of the index value is the amount of money. However, for example, when the feature quantity is average working hours or the like, the unit of the index value is a time.

Specifically, for example, the acquisition unit 101 may acquire the index value by calculating the index value using the objective function and the solution. Alternatively, a device different from the visualization device 10 may calculate the index value, and the acquisition unit 101 may acquire the index value from the device. The timing at which the acquisition unit 101 acquires the index value is not particularly limited. For example, the acquisition unit 101 may acquire the index value when receiving an instruction to compare the index values from the user.

The output control unit 102 outputs the index value acquired for the optimal solution among the plurality of solutions and the index value acquired for the feasible solution among the plurality of solutions in a comparable manner. The output format of the output control unit 102 is, for example, an output to an output device such as a display device or a sound output device, and is not particularly limited. For example, the output device may be included in the visualization device 10, or may be included in another device connected to the visualization device 10 through a communication network or the like.

Specifically, for example, the output control unit 102 may sort and output the index value acquired for the optimal solution and the index value acquired for the feasible solution in a predetermined order. For example, the predetermined order may be, for example, the descending order of the index values or the ascending order of the index values. This makes it easier for the user to select a solution having a better index value for the feature quantity. When sorting and outputting the index values, the output control unit 102 may output the index values in the same order.

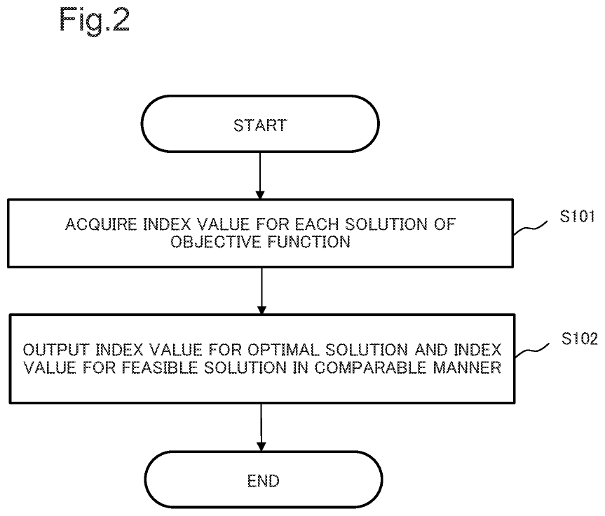

FIG. 2 is a flowchart illustrating an operation example of the visualization device 10 according to the first example embodiment. The acquisition unit 101 acquires an index value of a feature quantity for describing the objective function for each solution of the objective function (step S101). In step S101, the acquisition unit 101 may acquire the index value by calculating the index value. Alternatively, in step S101, a device different from the visualization device 10 may calculate the index value, and the acquisition unit 101 may acquire the index value from the device.

The output control unit 102 outputs the index value for the optimal solution and the index value for the feasible solution in a comparable manner (step S102). In step S102, the output control unit 102 may sort and output the index value acquired for the optimal solution and the index value acquired for the feasible solution in descending order.

As described above, in the first example embodiment, the visualization device 10 outputs the index value for the optimal solution obtained based on the objective function and the index value for the feasible solution in a comparable manner. As a result, it is possible to improve ease of checking each solution obtained by the objective function.

The first example embodiment is not limited to the example described above, and various modifications can be made. For example, each functional unit may be implemented by one device such as one server or one terminal device operable by the user. Alternatively, each functional unit may be implemented as a system using a plurality of devices.

### Second Example Embodiment

Next, a second example embodiment will be described in detail with reference to the drawings. In the second example embodiment, a specific example, such as a screen example in which an index value for a feasible solution and an index value for an optimal solution are compared and output, will be described. Hereinafter, description of contents overlapping the above description will be omitted to the extent that the description of the second example embodiment is not unclear.

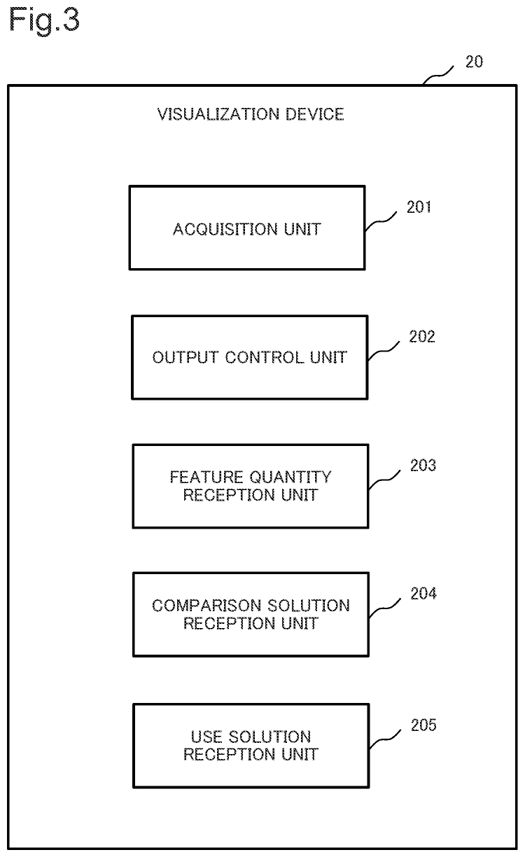

FIG. 3 is a block diagram illustrating a configuration example of a visualization device according to a second example embodiment. A visualization device 20 includes an acquisition unit 201, an output control unit 202, a feature quantity reception unit 203, a comparison solution reception unit 204, and a use solution reception unit 205. In the second example embodiment, the feature quantity reception unit 203, the comparison solution reception unit 204, and the use solution reception unit 205 are newly added to the first example embodiment. The acquisition unit 201 and the output control unit 202 have the basic functions of the acquisition unit 101 and the output control unit 102 described in the first example embodiment, respectively.

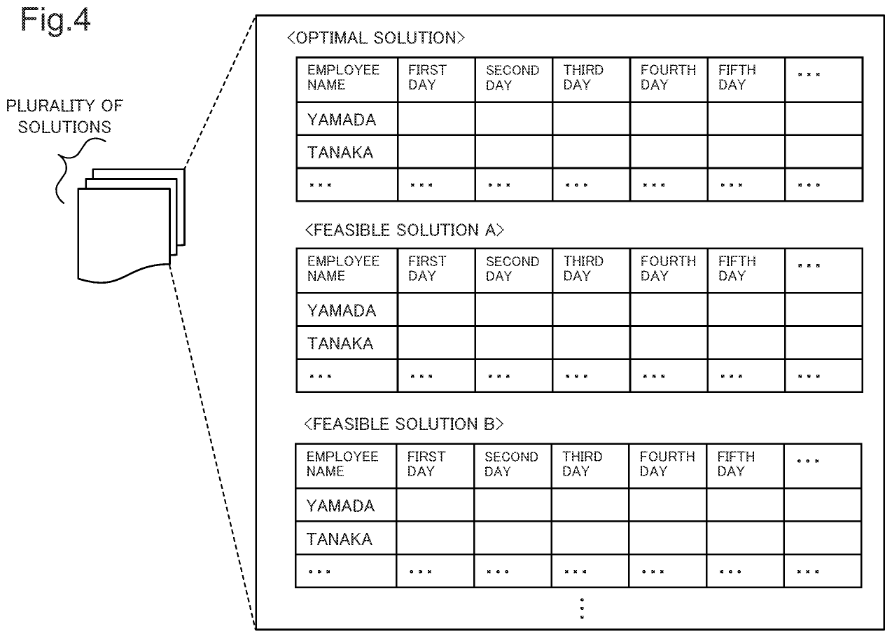

FIG. 4 is an explanatory diagram illustrating an example of a plurality of solutions. An objective function of the work of determining the work time schedule will be described as an example. Therefore, in FIG. 4, each solution is a work time schedule for each employee. As illustrated in FIG. 4, the work time schedule of the employee differs for each solution. Although FIG. 4 illustrates an optimal solution, a feasible solution A, and a feasible solution B, the number of feasible solutions is not particularly limited.

### (Focusing on One Feature Quantity)

Returning to the description of FIG. 3, first, a case where one feature quantity is designated from a plurality of feature quantities will be described as an example.

As described in the first example embodiment, the acquisition unit 201 acquires the index value of the feature quantity in each of a plurality of different solutions obtained based on the objective function having the factor of the action as the feature quantity. The feature quantity herein may be a feature quantity designated by the user from a plurality of feature quantities. An example of receiving designation of a feature quantity will be described. The feature quantity reception unit 203 may receive selection of any feature quantity from a plurality of feature quantities by the user's operation. The device to be operated by the user may be an input device of the visualization device 20 or may be a terminal device of the user connected to the visualization device 20 through a communication network or the like, and is not particularly limited. In the following description, a device to be operated by the user when other information is received is similarly not particularly limited.

Then, as described in the first example embodiment, the output control unit 202 outputs the index value acquired for the optimal solution and the index value acquired for the feasible solution in a comparable manner. The output format is not particularly limited. For example, the output device may be included in the visualization device 20, or may be included in another device connected to the visualization device 20 through a communication network or the like.

Specifically, for example, as described in the first example embodiment, the output control unit 202 may sort and output the index value acquired for the optimal solution and the index value acquired for the feasible solution in a predetermined order.

Alternatively, for example, the output control unit 202 may output a difference between the index value acquired for the optimal solution and the index value acquired for the feasible solution. For example, the difference may be a value obtained by subtracting the index value obtained for the feasible solution from the index value obtained for the optimal solution, or may be a value obtained by subtracting the index value obtained for the optimal solution from the index value obtained for the feasible solution, and is not particularly limited.

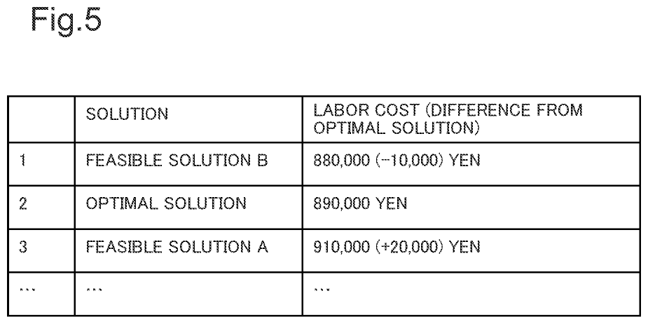

FIG. 5 is an explanatory diagram illustrating a screen example of comparison display of index values. In FIG. 5, the feature quantity is labor cost as an example, and the index value is the amount of the labor cost. In FIG. 5, the output control unit 202 displays each amount on the display device. In FIG. 5, the output control unit 202 displays the labor cost for the optimal solution and the labor cost for the feasible solution side by side in ascending order of the labor cost. The output control unit 202 outputs the amount in the same order. The output control unit 202 outputs, for the feasible solution, a difference between the labor cost for the optimal solution and the labor cost for the feasible solution. In FIG. 5, the difference is a value obtained by subtracting the labor cost of the optimal solution from the labor cost of the feasible solution B.

In FIG. 5, for example, the amount of labor cost for each of the optimal solution, the feasible solution A, and the feasible solution B is displayed. According to FIG. 5, the labor cost of the feasible solution B is 880000 yen, which is the lowest. The labor cost of the optimal solution is 89000 yen, which is the second lowest. The labor cost of the feasible solution A is 910000 yen, which is the third lowest. According to FIG. 5, the difference between the labor cost of the feasible solution B and the labor cost of the optimal solution is −10000 yen. According to FIG. 5, the difference between the labor cost of the feasible solution B and the labor cost of the optimal solution is +20000 yen.

In this manner, when focusing on the labor cost, the feasible solution B may be better than the optimal solution. For example, even if the user normally selects the optimal solution, the user may select the feasible solution B when the user desires to place more importance on the labor cost.

Returning to the description of FIG. 3, for example, the output control unit 202 selects a predetermined number of feasible solutions among a plurality of feasible solutions based on a predetermined order of index values. The output control unit 202 outputs the index values for the predetermined number of selected feasible solutions and the index value for the optimal solution in a comparable manner. The predetermined order of the index values is the descending order of index values or the ascending order of index values. The predetermined number may be a predetermined fixed value or a number newly designated by the user.

The output control unit 202 may graphically output the index value for the optimal solution and the index value for the feasible solution. The type of graph is not particularly limited, such as a bar graph, a pie graph, or a band graph.

### (Plurality of Feature Quantities)

Although the case where one feature quantity is designated by the user has been described as an example, the present invention is not limited to this example, and a plurality of feature quantities for describing the objective function may be designated by the user, and the index value may be acquired for each of the plurality of feature quantities.

The acquisition unit 201 acquires, for each of the plurality of solutions, an index value for each of the plurality of feature quantities in the objective function.

Similarly to the example described with one feature quantity, the index value for each of the plurality of designated feature quantities may be acquired. Specifically, for example, the feature quantity reception unit 203 may receive designation of some feature quantities from a plurality of feature quantities by the user's operation. As described above, the device to be operated by the user is not particularly limited. Then, for example, the acquisition unit 201 acquires the index value for each of the plurality of feature quantities designated by the user.

Then, when the index value is acquired for each of the plurality of feature quantities, the output control unit 202 outputs the index value acquired for each of the plurality of solutions in such a way that the index values for a predetermined feature quantity among the plurality of feature quantities are in a predetermined order. The predetermined feature quantity may be a fixed feature quantity, or may be a feature quantity designated by the user.

An example in which the feature quantity is designated by the user will be described. For example, the feature quantity reception unit 203 may receive selection of any feature quantity from a plurality of feature quantities by the user's operation. As described above, the device to be operated by the user is not particularly limited.

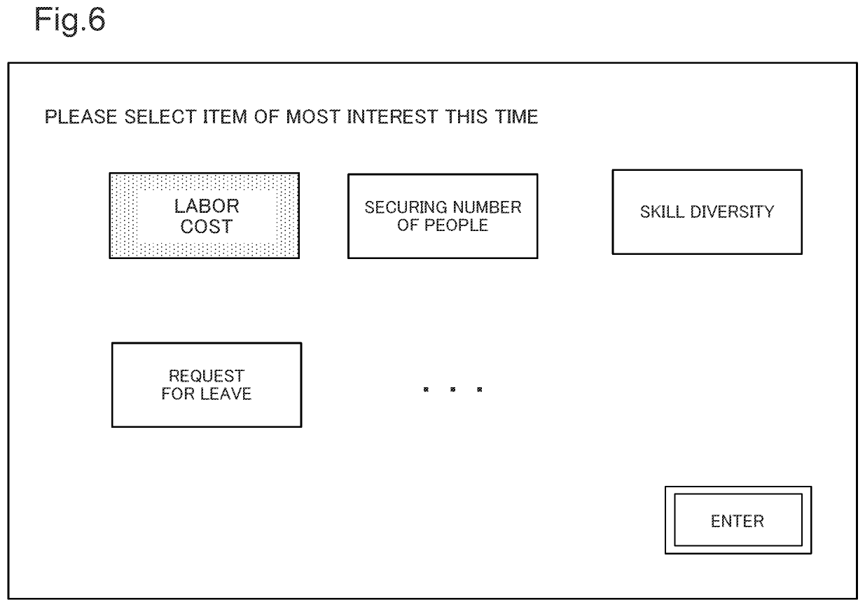

FIG. 6 is an explanatory diagram illustrating a screen example for selecting a feature quantity of interest. In FIG. 6, for example, the output control unit 202 displays a screen, on which a feature quantity of most interest among a plurality of feature quantities can be selected, on the display device. In FIG. 6, buttons capable of selecting a feature quantity are displayed for each feature quantity. In FIG. 6, the feature quantity “labor cost” is selected. For example, when the “determine” button is tapped, the feature quantity reception unit 203 receives selection of the feature quantity “labor cost”.

Then, the output control unit 202 outputs the index value acquired for each feature quantity for each of the plurality of solutions in such a way that the index values for the feature quantity “labor cost” are in a predetermined order (for example, in ascending order).

Returning to the description of FIG. 3, when there is a plurality of feasible solutions, if all the feasible solutions are output, it is difficult for the user to compare the index values and it is difficult to select a solution. Therefore, the output control unit 202 may output the index value for a predetermined number of feasible solutions selected based on a predetermined order of the index values among the plurality of feasible solutions and the index value for the optimal solution. As a result, it is possible to narrow down a plurality of feasible solutions to some feasible solutions and compare index values.

The output control unit 202 graphically outputs the index value acquired for the optimal solution among the plurality of solutions and the index value acquired for the feasible solution among the plurality of solutions. The type of graph is not particularly limited, such as a line graph, a bar graph, a pie chart, or a band graph.

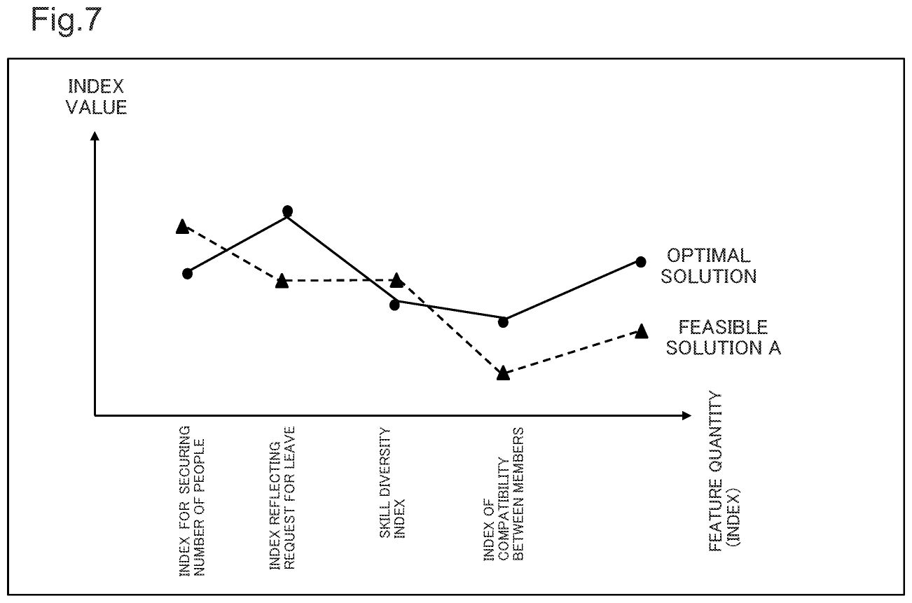

FIG. 7 is an explanatory diagram illustrating a screen example on which a graph is displayed. In FIG. 7, the output control unit 202 displays a line graph of the index value for each solution. In the line graph of FIG. 7, the horizontal axis indicates the feature quantity, and the vertical axis indicates the index value of the feature quantity. The vertical axis is a unit different for each feature quantity. The index value may be normalized in such a way that the unit is the same when graphically expressing the index value.

In the example of FIG. 7, a line graph showing the index value of each feature quantity for each of the optimal solution and the feasible solution A is displayed. In this manner, the index values for some of the plurality of feasible solutions and the index values for the optimal solution may be displayed. Some of the feasible solutions may be designated by the user, or may be a predetermined number (for example, one) of feasible solutions in order of best among the plurality of solutions.

The order of arrangement of the feature quantities in the line graph is not particularly limited. For example, the designated feature quantity may be displayed at the head. In the designation method, similarly to the above example, the feature quantity reception unit 203 may receive designation of the feature quantity. Alternatively, although not illustrated, the feature quantities may be arranged in descending order of the difference between the index value for the optimal solution and the index value for the feasible solution. When the units of the index values are different, the normalized differences may be compared.

Although not illustrated, the output control unit 202 may highlight a feature quantity having a large difference between the index value for the optimal solution and the index value for the feasible solution. Specifically, for example, the output control unit 202 may highlight the index value of the feature quantity or may highlight the name of the feature quantity.

This is the end of the description of the case where there is a plurality of feature quantities.

### (Plurality of Objective Functions)

Although the case where there is one objective function has been described above as an example, a plurality of different objective functions may be derived. The plurality of objective functions is created by different decision-making histories for the same action. For example, the plurality of objective functions is created by a decision-making history of the subject for each subject, or created by a decision-making history at different timings such as different time zones even for the same subject.

The acquisition unit 201 acquires an index value of a feature quantity for each of a plurality of solutions derived for each of a plurality of different objective functions. As described above, the index value may be acquired for each of the plurality of feature quantities.

Then, the output control unit 202 outputs the index value for the optimal solution and the index value for the feasible solution in a comparable manner for each of the plurality of different objective functions. For example, in the case of graphing, the output control unit 202 may output a graph for each objective function. Alternatively, the output control unit 202 may superimpose and output a graph for each of a plurality of different objective functions for the same index value.

### (Designation of Feasible Solution to be Compared)

For example, when there is a plurality of feasible solutions, the index value for the feasible solution designated by the user may be compared with the index value for the optimal solution. For example, the output control unit 202 may display a feasible solution. Then, the comparison solution reception unit 204 receives designation of a feasible solution to be compared from a plurality of feasible solutions by the user's operation. As described above, the device to be operated by the user is not particularly limited. The number of feasible solutions designated herein is not particularly limited. Then, the acquisition unit 201 may acquire the index value for the objective function for the designated feasible solution and optimal solution.

### (Designation of Solution to be Used)

The user selects a solution to be used according to the comparison of the index values. Therefore, the use solution reception unit 205 receives designation of a solution to be used among the plurality of solutions by the user's operation. For example, the output control unit 202 may output the designated solution.

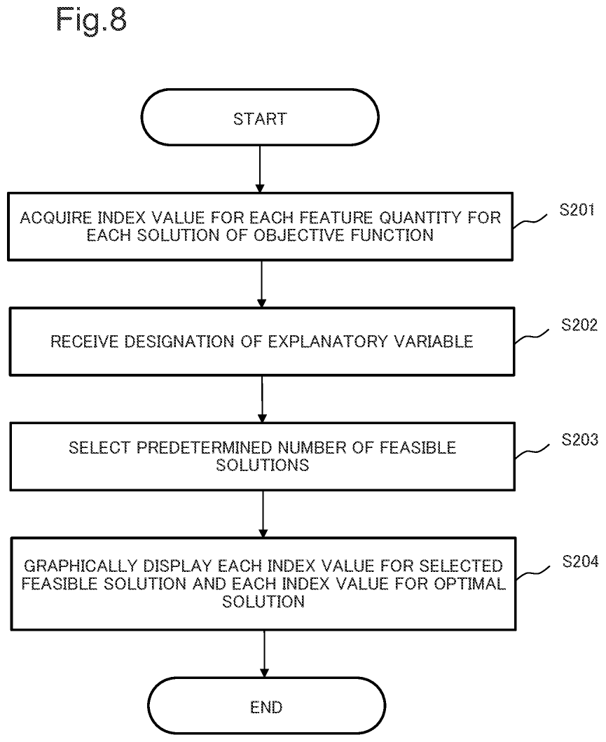

FIG. 8 is a flowchart illustrating an operation example of the visualization device 20 according to the second example embodiment. The operation example of FIG. 8 is an example in which there is one objective function, a predetermined number of feasible solutions are selected in the order of the index values of the feature quantity designated by the user, and the index values of the selected predetermined number of feasible solutions and the optimal solution are compared and output.

The acquisition unit 201 acquires an index value for each feature quantity for each solution of the objective function (step S201). Then, the feature quantity reception unit 203 receives designation of a feature quantity (step S202). The order of the processing of step S201 and step S202 is not limited to the order of FIG. 8, and step S201 may be executed after step S202.

The output control unit 202 selects a predetermined number of feasible solutions based on a predetermined order of the index values of the designated feature quantities (step S203). The predetermined order of the index values is the descending order of index values or the ascending order of index values. Then, the output control unit 202 graphically displays each index value for the selected feasible solution and each index value for the optimal solution on the display device (step S204).

As described above, in the second example embodiment, the visualization device 20 outputs the index values of a predetermined number of feasible solutions selected based on a predetermined order of index values among a plurality of solutions and the index values of the optimal solutions in a comparable manner. As a result, it is possible to narrow down the feature quantity regarded as important by the user to a better feasible solution and compare it with the optimal solution. Therefore, it is possible to improve ease of checking each solution obtained by the objective function.

The visualization device 20 outputs the index values of the solutions in a predetermined order. For example, the visualization device 20 outputs the index values side by side in a predetermined order. As a result, it is possible to easily check a solution having a good index value for the feature quantity that is regarded as important by the user. Therefore, it is possible to improve ease of checking each solution obtained by the objective function.

The visualization device 20 graphically outputs the index value acquired for the optimal solution and the index value acquired for the feasible solution. Thus, comparison can be made in an easily viewable format. Therefore, it is possible to improve ease of checking each solution obtained by the objective function. The visualization device 20 may acquire the index value for each of the plurality of feature quantities in the objective function for each of the plurality of solutions and graphically output the index value acquired for the optimal solution and the index value acquired for the feasible solution. As a result, in the optimal solution and the feasible solution, the index value for each of various feature quantities can be compared in an easily viewable format. Therefore, it is possible to improve ease of checking each solution obtained by the objective function.

The feasible solution may be a designated feasible solution among the plurality of solutions. As a result, it is possible to compare the index value for the feasible solution that the user desires to check with the index value for the optimal solution.

The visualization device 20 outputs a difference between the index value for the optimal solution and the index value for the feasible solution. This makes it possible to visualize the degree of quality of the index value for each feasible solution with respect to the index value for the optimal solution.

The visualization device 20 acquires the index value for each of the plurality of feature quantities in the objective function for each of the plurality of solutions, and outputs the index value acquired for each of the plurality of solutions in such a way that the index value for a predetermined feature quantity among the plurality of feature quantities is in a predetermined order. As a result, in the optimal solution and the feasible solution, the index value for each of various feature quantities can be compared. Therefore, it is possible to improve ease of checking each solution obtained by the objective function.

This is the end of the description of each example embodiment. The example embodiments may be used in combination. For example, in each example embodiment, the visualization device may include each functional unit and a part of information.

In each example embodiment, the work time schedule is taken as an example, but the work is not particularly limited as described above. For example, taking the work of determining the delivery route as an example, the feature quantity may be a time taken for delivery, an index of a customer such as a degree of promise of a customer included in the delivery route, a degree of appropriateness of a driver who delivers a product, and the like.

Each example embodiment is not limited to the above-described examples, and various modifications can be made. The configuration of the visualization device in each example embodiment is not particularly limited. Each functional unit described in the example embodiment may be implemented by one device (visualization device) or may be implemented by a plurality of different devices.

A button, an information display field, an input field, and the like (not illustrated) may be added to each screen. In each screen, the position, color, and size of each item such as a button, an input field, and a display field are not particularly limited. The background color of the screen and the like may be changed.

For example, in each example embodiment, when the display device as an output device is provided by a device different from the visualization device, the processing of generating information or the like of the screen to be displayed on the display device may be performed by the output control units 102 and 202, or may be performed by a device including the display device.

### (Computer)

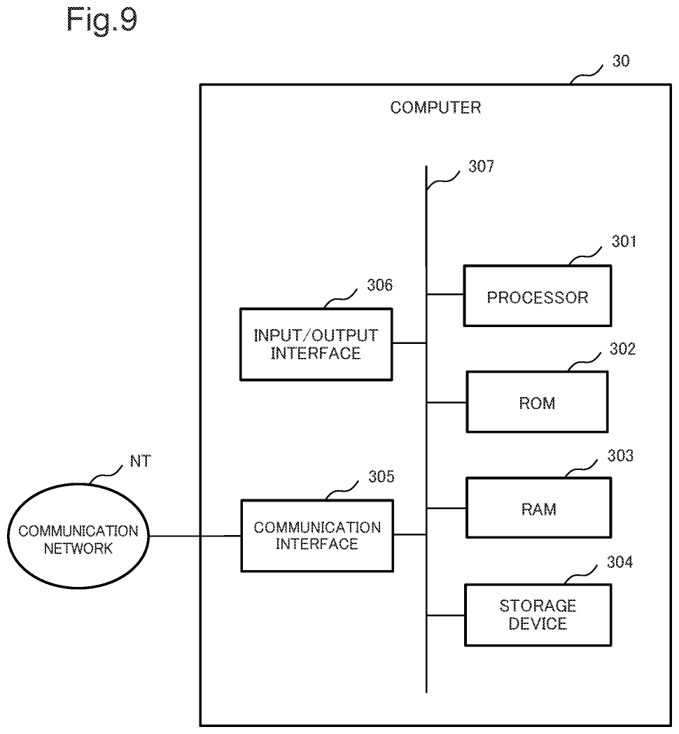

Next, a hardware configuration example when the visualization device described in each example embodiment is implemented by a computer will be described. FIG. 9 is an explanatory diagram illustrating a hardware configuration example of a computer. For example, some or all of the devices can be implemented by using any combination of the computer 30 and the program illustrated in FIG. 9, for example.

The computer 30 includes, for example, a processor 301, a read only memory (ROM) 302, a random access memory (RAM) 303, a storage device 304, a communication interface 305, and an input/output interface 306. The components are connected to each other through a bus 307.

The processor 301 controls the entire computer 30. Examples of the processor 301 include a central processing unit (CPU), a digital signal processor (DSP), and a graphics processing unit (GPU). The number of processors 301 may be plural. The computer 30 includes the ROM 302, the RAM 303, the storage device 304, and the like as storage units. Examples of the storage device 304 include a semiconductor memory such as a flash memory, a hard disk drive (HDD), and a solid state drive (SSD). For example, the storage device 304 stores an operating system (OS) program, an application program, a program according to each example embodiment, and the like. Alternatively, the ROM 302 stores an application program, a program according to each example embodiment, and the like. Then, the RAM 303 is used as a work area of the processor 301.

The processor 301 loads a program stored in the storage device 304, the ROM 302, or the like. Then, the processor 301 executes each processing (each processing instruction) coded in the program. The processor 301 may download various programs through the communication network NT. The processor 301 functions as a part or entirety of the computer 30. Then, the processor 301 may execute processing or instructions in the illustrated flowchart based on the program.

The communication interface 305 is connected to the communication network NT, such as a local area network (LAN) or a wide area network (WAN), through a wireless or wired communication line. The communication network NT may include a plurality of communication networks. As a result, the computer 30 is connected to an external device or an external computer through the communication network NT. The communication interface 305 manages an interface between the communication network NT and the inside of the computer 30. Then, the communication interface 305 controls input and output of data from an external device or an external computer.

The input/output interface 306 is connected to at least one of an input device, an output device, and an input/output device. The connection method may be wireless or wired. Examples of the input device include a keyboard, a mouse, and a microphone. Examples of the output device include a display device, a lighting device, and a speaker that is a sound output device that outputs a sound. Examples of the input/output device include a touch panel display. The input device, the output device, the input/output device, and the like may be built in the computer 30 or may be externally attached.

The hardware configuration of the computer 30 is an example. The computer 30 may have some components illustrated in FIG. 9. The computer 30 may have components other than those illustrated in FIG. 9. For example, the computer 30 may include a drive device or the like. Then, the processor 301 may read a program or data stored in a recording medium installed in a drive device or the like into the RAM 303. Examples of the non-transitory tangible recording medium include an optical disk, a flexible disk, a magnetic optical disk, and a universal serial bus (USB) memory. As described above, for example, the computer 30 may include an input device such as a keyboard and a mouse. The computer 30 may include an output device such as a display. The computer 30 may include an input device, an output device, and an input/output device. The computer 30 may include various sensors (not illustrated). The type of sensors is not particularly limited.

This is the end of the description of the hardware configuration of the visualization device. There are various modifications of the method for implementing the visualization device. For example, the visualization device may be implemented by any combination of a computer and a program different for each component. A plurality of components included in the visualization device may be implemented by any combination of one computer and a program.

Some or all of the components of each device such as the visualization device may be implemented by an application specific circuit. A part or entirety of each device may be implemented by a general-purpose circuit including a processor such as a field programmable gate array (FPGA). A part or entirety of each device may be implemented by a combination of an application specific circuit, a general-purpose circuit, and the like. These circuits may be a single integrated circuit. Alternatively, these circuits may be divided into a plurality of integrated circuits. The plurality of integrated circuits may be configured by being connected to each other through a bus or the like.

When a part or entirety of each component of each device is implemented by a plurality of computers, circuits, and the like, the plurality of computers, circuits, and the like may be arranged in a centralized manner or in a distributed manner.

The visualization method described in each example embodiment is implemented by a computer such as a visualization device. The visualization method is implemented by a computer such as a visualization device executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. The program may be distributed through the communication network NT.

The function of each component of each device such as the visualization device in each example embodiment described above may be implemented by hardware like a computer. Alternatively, each component may be implemented by a computer or firmware based on program control.

Although the present disclosure has been described with reference to the example embodiments, the present disclosure is not limited to the example embodiments. The configuration and details of each present disclosure may include example embodiments to which various changes that can be grasped by those skilled in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order of executing the plurality of operations. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.
(Supplementary Note 1)

A visualization method including:
acquiring, for each of a plurality of solutions different from one another of an optimization problem obtained based on an objective function, a value of a feature quantity of the objective function in each of the solutions; and
outputting a value of the feature quantity acquired for an optimal solution among the plurality of solutions and a value of the feature quantity acquired for a feasible solution among the plurality of solutions in a comparable manner.
(Supplementary Note 2)

The visualization method described in Supplementary Note 1,
wherein, in the outputting, among the plurality of solutions, values of the feature quantities for a predetermined number of the feasible solutions selected based on a predetermined order of the values of the feature quantities and values of the feature quantities for the optimal solution are output in a comparable manner.
(Supplementary Note 3)

The visualization method described in Supplementary Note 1 or 2,
wherein, in the outputting, the values of the feature quantities are output in a predetermined order.
(Supplementary Note 4)

The visualization method described in Supplementary Notes 1 to 3,
wherein, in the outputting, the value of the feature quantity acquired for the optimal solution and the value of the feature quantity acquired for the feasible solution are graphically output.
(Supplementary Note 5)

The visualization method described in Supplementary Notes 1 to 4,
wherein the feasible solution is a designated feasible solution among the plurality of solutions.
(Supplementary Note 6)

The visualization method described in Supplementary Notes 1 to 5,
wherein, in the outputting, a difference between the value of the feature quantity for the optimal solution and the value of the feature quantity for the feasible solution is output.
(Supplementary Note 7)

The visualization method described in Supplementary Note 1 or 6,
wherein, in the acquiring, for each of the plurality of solutions, a value of a feature quantity for each of a plurality of feature quantities in the objective function is acquired, and
in the outputting, the value of the feature quantity acquired for each of the plurality of solutions is output in such a way that the value of the feature quantity for a predetermined feature quantity among the plurality of feature quantities is in a predetermined order.
(Supplementary Note 8)

The visualization method described in Supplementary Notes 1 to 7,
wherein the objective function is an objective function generated by inverse reinforcement learning.
(Supplementary Note 9)

A visualization device including:
an acquisition means for acquiring, for each of a plurality of solutions different from one another of an optimization problem obtained based on an objective function, a value of a feature quantity of the objective function in each of the solutions; and
an output control means for outputting a value of the feature quantity acquired for an optimal solution among the plurality of solutions and a value of the feature quantity acquired for a feasible solution among the plurality of solutions in a comparable manner.
(Supplementary Note 10)

The visualization device described in Supplementary Note 9,
wherein the objective function is an objective function generated by inverse reinforcement learning.
(Supplementary Note 11)

A non-transitory computer-readable recording medium that records a program causing a computer to execute processing for:
acquiring, for each of a plurality of solutions different from one another of an optimization problem obtained based on an objective function, a value of a feature quantity of the objective function in each of the solutions; and
outputting a value of the feature quantity acquired for an optimal solution among the plurality of solutions and a value of the feature quantity acquired for a feasible solution among the plurality of solutions in a comparable manner.
(Supplementary Note 12)

The recording medium described in Supplementary Note 11,
wherein the objective function is an objective function generated by inverse reinforcement learning.
(Supplementary Note 13)

A program causing a computer to execute processing for:
acquiring, for each of a plurality of solutions different from one another of an optimization problem obtained based on an objective function, a value of a feature quantity of the objective function in each of the solutions; and
outputting a value of the feature quantity acquired for an optimal solution among the plurality of solutions and a value of the feature quantity acquired for a feasible solution among the plurality of solutions in a comparable manner.
(Supplementary Note 14)

The program described in Supplementary Note 13,
wherein the objective function is an objective function generated by inverse reinforcement learning.

### REFERENCE SIGNS LIST

10, 20 visualization device
30 computer
101, 201 acquisition unit
102, 202 output control unit
203 feature quantity reception unit
204 comparison solution reception unit
205 use solution reception unit
301 processor
302 ROM
303 RAM
304 storage device
305 communication interface
306 input/output interface
307 bus
A feasible solution
B feasible solution
NT communication network

What is claimed is:

1. A visualization method, implemented by a computer, comprising:
acquiring, for each of a plurality of solutions different from one another of an optimization problem obtained based on an objective function, a value of a feature quantity of the objective function in each of the solutions; and
outputting a value of the feature quantity acquired for an optimal solution among the plurality of solutions and a value of the feature quantity acquired for a feasible solution among the plurality of solutions in a comparable manner.

2. The visualization method according to claim 1,
wherein, in the outputting, among the plurality of solutions, values of the feature quantities for a predetermined number of the feasible solutions selected based on a predetermined order of the values of the feature quantities and values of the feature quantities for the optimal solution are output in a comparable manner.

3. The visualization method according to claim 1,
wherein, in the outputting, the values of the feature quantities are output in a predetermined order.

4. The visualization method according to claim 1,
wherein, in the outputting, the value of the feature quantity acquired for the optimal solution and the value of the feature quantity acquired for the feasible solution are graphically output.

5. The visualization method according to claim 1,
wherein the feasible solution is a designated feasible solution among the plurality of solutions.

6. The visualization method according to claim 1,
wherein, in the outputting, a difference between the value of the feature quantity for the optimal solution and the value of the feature quantity for the feasible solution is output.

7. The visualization method according to claim 1,
wherein, in the acquiring, for each of the plurality of solutions, a value of a feature quantity for each of a plurality of feature quantities in the objective function is acquired, and
in the outputting, the value of the feature quantity acquired for each of the plurality of solutions is output in such a way that the value of the feature quantity for a predetermined feature quantity among the plurality of feature quantities is in a predetermined order.

8. The visualization method according to claim 1,
wherein the objective function is an objective function generated by inverse reinforcement learning.

9. A visualization device comprising:
a memory storing instructions; and
at least one processor configured to execute the instructions to:
acquire, for each of a plurality of solutions different from one another of an optimization problem obtained based on an objective function, a value of a feature quantity of the objective function in each of the solutions; and
output a value of the feature quantity acquired for an optimal solution among the plurality of solutions and a value of the feature quantity acquired for a feasible solution among the plurality of solutions in a comparable manner.

10. The visualization device according to claim 9,
wherein the objective function is an objective function generated by inverse reinforcement learning.

11. A non-transitory recording medium that is readable by a computer and records a program causing the computer to execute processing for:
acquiring, for each of a plurality of solutions different from one another of an optimization problem obtained based on an objective function, a value of a feature quantity of the objective function in each of the solutions; and
outputting a value of the feature quantity acquired for an optimal solution among the plurality of solutions and a value of the feature quantity acquired for a feasible solution among the plurality of solutions in a comparable manner.

12. The recording medium according to claim 11,
wherein the objective function is an objective function generated by inverse reinforcement learning.
